(19) United States
(12) Patent Application Publication
(10) Pub. No.: US 2026/0019945 A1
(43) Pub. Date: Jan. 15, 2026

(54) UNAVAILABILITY SCHEDULE MODIFICATION

(71) Applicant: Samsung Electronics Co., Ltd., Suwon-si (KR)

(72) Inventors: Rubayet Shafin, Allen, TX (US); Boon Loong Ng, Plano, TX (US); Peshal Nayak, Plano, TX (US); Vishnu Vardhan Ratnam, Plano, TX (US); Yue Qi, Plano, TX (US); Bilal Sadiq, Plano, TX (US)

(21) Appl. No.: 19/258,756

(22) Filed: Jul. 2, 2025

Related U.S. Application Data
(60) Provisional application No. 63/669,596, filed on Jul. 10, 2024.
(60) Provisional application No. 63/671,646, filed on Jul. 15, 2024.

(51) Int. Cl. H04W 52/02; H04W 74/0816

(52) U.S. Cl. CPC H04W 52/0216; H04W 52/0274; H04W 74/0816

(57) ABSTRACT

Disclosed is a mechanism for a STA to change parameters of the unavailability schedule or P2P TWT schedule that has been set up with an AP. The STA establishes a unavailability schedule agreement with an associated AP. The STA enters a power save mode during a nominal unavailability SP based on the unavailability schedule agreement. The STA is unavailable to communicate with the AP during the nominal unavailability SP due to scheduled P2P communication with a second STA. The STA transmits to the AP a request indicating a change to the unavailability schedule agreement. The STA enters the power save mode during a modified unavailability SP based on the change to the unavailability schedule agreement. The modified unavailability SP is changed from the nominal unavailability SP. The change may include a different start time, a different end time, a different period, and/or a different interval.

### CROSS-REFERENCE TO RELATED APPLICATIONS

This application claims the benefit of priority from U.S. Provisional Application No. 63/669,596 entitled “UNAVAILABILITY SCHEDULE MODIFICATION,” filed on Jul. 10, 2024, and U.S. Provisional Application No. 63/671,646 entitled “TWT INFORMATION FRAME USAGE FOR HANDLING COEX EVENTS,” filed on Jul. 15, 2024, the disclosure of all of which is incorporated herein by reference in its entirety.

### TECHNICAL FIELD

This disclosure relates generally to a wireless communication system, and more particularly to, but not limited to, an unavailability schedule of a device in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a STA in a wireless network. The STA includes a memory and a processor coupled to the memory. The processor is configured to cause the STA to establish an unavailability schedule agreement with an AP and to enter a power save mode during a nominal unavailability service period (SP) based on the unavailability schedule agreement. The STA is unavailable to communicate with the AP during the nominal unavailability SP. The processor is further configured to cause the STA to transmit, to the AP, a request indicating a change to the unavailability schedule agreement, and to enter the power save mode during a modified unavailability SP based on the change to the unavailability schedule agreement. The modified unavailability SP is changed from the nominal unavailability SP.

In one embodiment, when the STA establishes the unavailability schedule agreement with the AP, the processor is configured to cause the STA to transmit, to the AP, a channel usage request frame. The channel usage request frame includes a set of target wake time (TWT) parameters associated with the nominal unavailability SP. The processor is further configured to cause the STA to receive, from the AP, a channel usage response frame that accepts the set of TWT parameters.

In one embodiment, the TWT parameters includes one or more of: a start time of the nominal unavailability SP; an end time of the nominal unavailability SP; a period of a sequence of nominal unavailability SPs; or an interval of the nominal unavailability SP.

In one embodiment, when the STA transmits the request indicating the change to the unavailability schedule agreement, the processor is configured to cause the STA to transmit, to the AP, an unavailability modification request frame. The unavailability modification request frame indicates a change to a TWT parameter associated with the nominal unavailability SP. The processor is further configured to cause the STA to receive, from the AP, an unavailability modification response frame that accepts the change to the TWT parameter.

In one embodiment, the change to the TWT parameter includes a change to one or more of: a start time of the nominal unavailability SP; an end time of the nominal unavailability SP; a period of a plurality of the nominal unavailability SPs; or an interval of the nominal unavailability SP.

In one embodiment, the request indicates the change to the unavailability schedule agreement starting from a next nominal unavailability SP of a sequence of nominal unavailability SPs following the request.

In one embodiment, the request indicates the change to the unavailability schedule agreement starting from a k-th nominal unavailability SP of a sequence of nominal unavailability SPs following the request.

In one embodiment, when the STA transmits the request indicating the change to the unavailability schedule agreement, the processor is configured to cause the STA to transmit, to the AP, a TWT information frame. The TWT information frame indicates a change to a TWT parameter associated with the nominal unavailability SP. The processor is further configured to cause the STA to receive, from the AP, a response frame that accepts the change to the TWT parameter.

An aspect of the disclosure provides an AP in a wireless network. The AP includes a memory and a processor coupled to the memory. The processor is configured to cause the AP to establish an unavailability schedule agreement with a STA and to determine a nominal unavailability service period (SP) of the STA based on the unavailability schedule agreement. The AP is unavailable to communicate with the STA during the nominal unavailability SP. The processor is further configured to cause the AP to receive, from the STA, a request indicating a change to the unavailability schedule agreement, and to determine a modified unavailability SP based on the change to the unavailability schedule agreement. The modified unavailability SP is changed from the nominal unavailability SP.

In one embodiment, when the AP establishes the unavailability schedule agreement with the STA, the processor is configured to cause the AP to receive, from the STA, a channel usage request frame. The channel usage request frame includes a set of TWT parameters associated with the nominal unavailability SP. The processor is further configured to cause the AP to transmit, to the STA, a channel usage response frame that accepts the set of TWT parameters.

In one embodiment, the TWT parameters includes one or more of: a start time of the nominal unavailability SP; an end time of the nominal unavailability SP; a period of a sequence of nominal unavailability SPs; or an interval of the nominal unavailability SP.

In one embodiment, when the AP receives the request indicating the change to the unavailability schedule agreement, the processor is configured to cause the AP to receive, from the STA, an unavailability modification request frame. The unavailability modification request frame indicates a change to a TWT parameter associated with the nominal unavailability SP. The processor is further configured to cause the AP to transmit, to the STA, an unavailability response frame that accepts the change to the TWT parameter.

In one embodiment, the change to the TWT parameter includes a change to one or more of: a start time of the nominal unavailability SP; an end time of the nominal unavailability SP; a period of a plurality of the nominal unavailability SPs; or an interval of the nominal unavailability SP.

In one embodiment, the request indicates the change to the unavailability schedule agreement starting from a next nominal unavailability SP of a sequence of nominal unavailability SPs following the request.

In one embodiment, the request indicates the change to the unavailability schedule agreement starting from a k-th nominal unavailability SP of a sequence of nominal unavailability SPs following the request.

In one embodiment, when the AP receives the request indicating the change to the unavailability schedule agreement, the processor is configured to cause the AP to receive, from the STA, a TWT information frame. The TWT information frame indicates a change to a TWT parameter associated with the nominal unavailability SP. The processor is further configured to cause the AP to transmit, to the STA, a response frame that accepts the change to the TWT parameter.

An aspect of the disclosure provides a method performed by a STA in a wireless network. The method includes establishing an unavailability schedule agreement with an AP. The method also includes entering a power save mode during a nominal unavailability service period (SP) based on the unavailability schedule agreement. The STA is unavailable to communicate with the AP during the nominal unavailability SP. The method further includes transmitting, to the AP, a request indicating a change to the unavailability schedule agreement, and entering the power save mode during a modified unavailability SP based on the change to the unavailability schedule agreement. The modified unavailability SP is changed from the nominal unavailability SP.

In one embodiment, for establishing the unavailability schedule agreement with the AP, the method includes transmitting, to the AP, a channel usage request frame. The channel usage request frame includes a set of TWT parameters associated with the nominal unavailability SP. The method also includes receiving, from the AP, a channel usage response frame that accepts the set of TWT parameters. The TWT parameters includes one or more of: a start time of the nominal unavailability SP; an end time of the nominal unavailability SP; a period of a sequence of nominal unavailability SPs; or an interval of the nominal unavailability SP.

In one embodiment, for transmitting the request indicating the change to the unavailability schedule agreement, the method includes transmitting, to the AP, one of an unavailability modification request frame or a TWT information frame. The unavailability modification request frame or the TWT information frame indicates a change to a TWT parameter associated with the nominal unavailability SP. The method also includes receiving, from the AP, a response frame that accepts the change to the TWT parameter. The change to the TWT parameter includes a change to one or more of: a start time of the nominal unavailability SP; an end time of the nominal unavailability SP; a period of a plurality of the nominal unavailability SPs; or an interval of the nominal unavailability SP.

In one embodiment, the request indicates the change to the unavailability schedule agreement starting one of a next nominal unavailability SP or a k-th nominal unavailability SP of a sequence of nominal unavailability SPs following the request.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows a network where infrastructure traffic and non-infrastructure traffic coexist in accordance with one embodiment.

FIG. 5 shows a STA1 indicating to its associated AP time periods during which the STA1 will be unavailable for frame exchange with the AP due to scheduled peer-to-peer (P2P) communication with a STA2 in accordance with one embodiment.

FIG. 6 shows the STA1 indicating to its associated AP time periods during which STA1 will be unavailable for frame exchange with the AP due to scheduled P2P co-existence event with the STA2 in accordance with one embodiment.

FIG. 7 shows the STA1 setting up an unavailability schedule or P2P target wake time (TWT) schedule with the AP1 in accordance with one embodiment.

FIG. 8 shows the STA1 indicating to its associated AP a change to the scheduled start or end time of future unavailability SP or P2P TWT SP in accordance with one embodiment.

FIG. 9 shows a delay to the nominal start time of the unavailability SP or P2P TWT SP that has been established based on a previous agreement in accordance with one embodiment.

FIG. 10 shows an advance to the nominal start time of the unavailability SP or P2P TWT SP that has been established based on a previous agreement in accordance with one embodiment.

FIG. 11 shows a delay to the nominal end time of the unavailability SP or P2P TWT SP that has been established based on a previous agreement in accordance with one embodiment.

FIG. 12 shows a delay to the nominal end time of the unavailability SP or P2P TWT SP that has been established based on a previous agreement in accordance with one embodiment.

FIG. 13 shows the STA1 indicating to its associated AP a change to the period or interval of future unavailability SP or P2P TWT SP in accordance with one embodiment.

FIG. 14 shows a change to the nominal period of the unavailability SP or P2P TWT SP that has been established based on a previous agreement in accordance with one embodiment.

FIG. 15 shows a delay to the nominal start time of the unavailability SP or P2P TWT SP that has been established based on a previous agreement where the delay takes effect starting from the next unavailability SP or P2P TWT SP after the STA1 indicates the delay in accordance with one embodiment.

FIG. 16 shows a delay to the nominal start time of the unavailability SP or P2P TWT SP that has been established based on a previous agreement where the delay takes effect starting from the third unavailability SP or P2P TWT SP after the STA1 indicates the delay in accordance with one embodiment.

FIG. 17 shows the STA1 and the AP1 exchanging unavailability modification request and response frames to modify parameters of the unavailability SP or P2P TWT SP established based on a previous agreement between the STA1 and the API in accordance with one embodiment.

FIG. 18 shows the STA1 and the AP1 exchanging TWT information and response frames to modify parameters of the unavailability SP or P2P TWT SP established based on a previous agreement between the STA1 and the AP1 in accordance with one embodiment.

FIG. 19 shows a flow diagram of a method of a STA modifying the unavailability SP or P2P TWT SP AP1 in accordance with one embodiment.

FIG. 20 shows a flow diagram of a method 2000 of an AP receiving a request from an AP to modify the unavailability SP or P2P TWT SP in accordance with one embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard.

However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

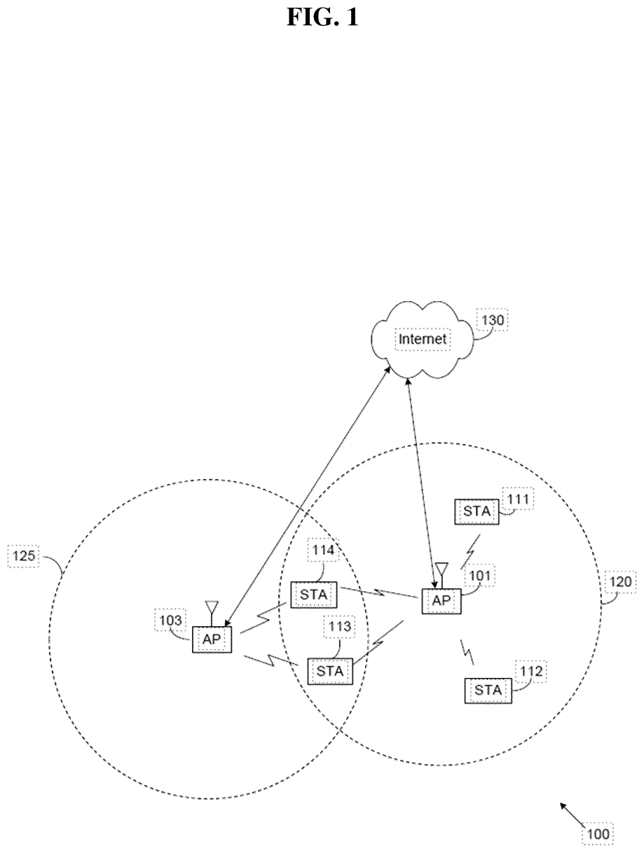

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs and variations in the radio environment associated with natural and man-made obstructions.

As described in more detail below, one or more of the APs may include circuitry and/or programming for management of multi-user MIMO (MU-MIMO) and orthogonal frequency division multiple access (OFDMA) channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

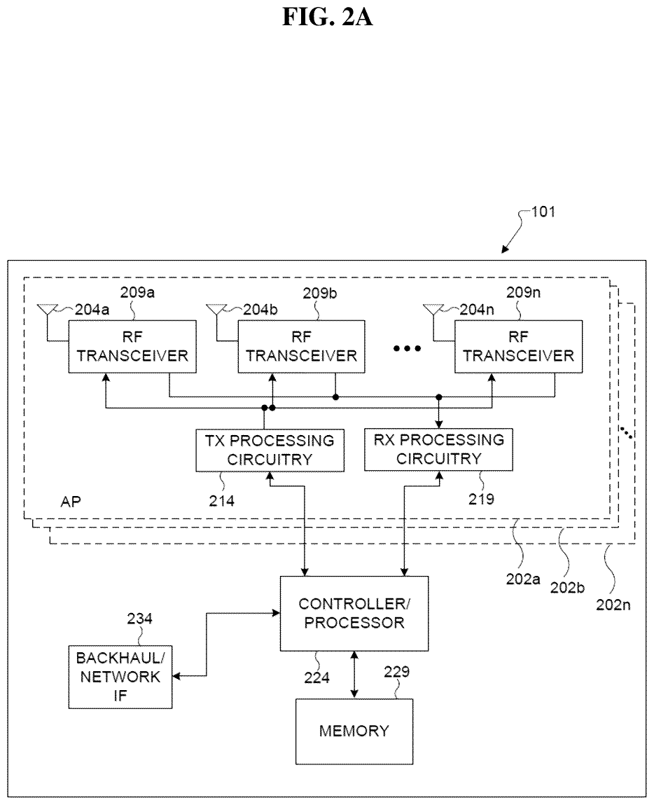

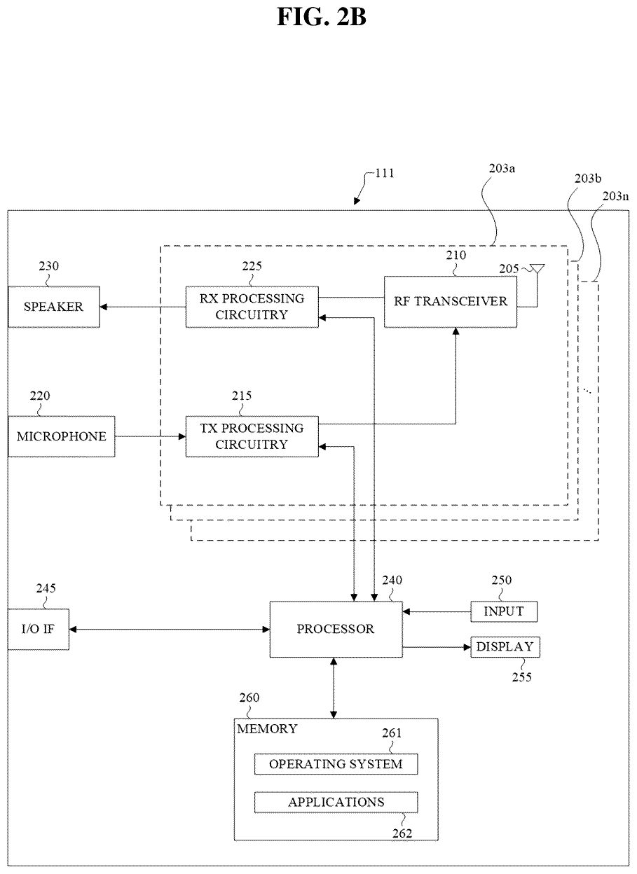

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

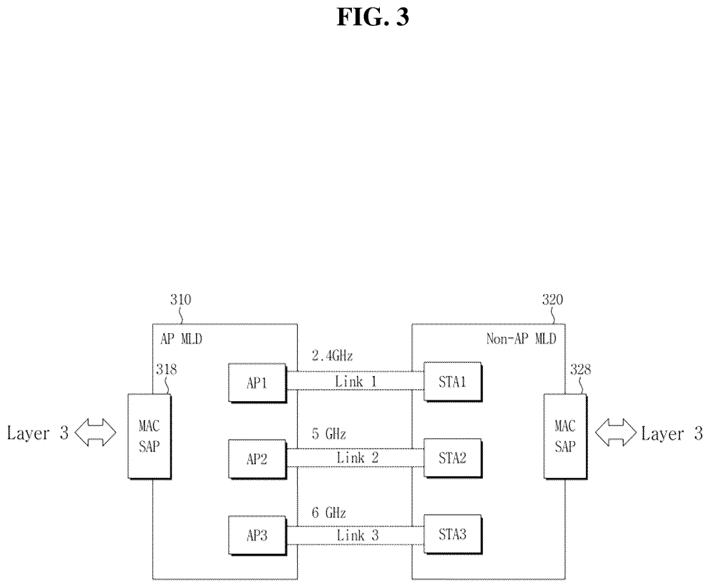

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” iii) IEEE P802.11be/D6.0, “Wireless LAN Medium Access Control (MAC) and Physical Layer (PHY) Specifications,” and iv) IEEE P802.11 REVme Draft D6.0 “Wireless LAN Medium Access Control (MAC) and Physical Layer (PHY) Specifications.”

Next generation WLAN system is to provide better support for low-latency applications. Today it is not uncommon to observe numerous devices operating on the same network. Many of such devices may be latency-tolerant but still contend with the devices with low-latency applications for the same time and frequency resources. In some cases, the AP as the network controller may not have enough control over the unregulated/unmanaged traffic that contends with the low-latency traffic within the infrastructure basic service set (BSS) of STAs served by the AP. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or peer-to-peer (P2P) networks. It is advantageous for the next generation WLAN system to have mechanisms to better handle the unmanaged traffic to prioritize the low-latency traffic in the network.

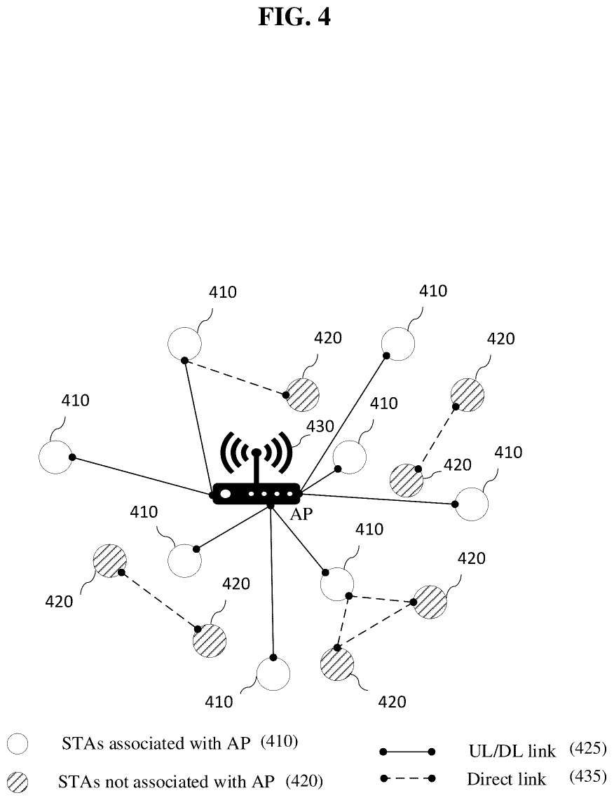

FIG. 4 shows a network where infrastructure traffic and non-infrastructure traffic coexist in accordance with one embodiment. An infrastructure BSS may include an AP 430 managing STAs 410 (also referred to as STAs 410 associated with AP 430). AP 430 and STAs 410 may communicate through uplinks/downlink channels (UL/DL) 425. FIG. 4 also shows STAs 420 that are not associated with AP 430, such as those in a neighboring BSS (OBSS) or from neighboring independent BSS. STAs 410 and STAs 420 may communicate with each other directly using a direct link 435 (P2P communication) without routing the traffic going through AP 430. The UL/DL 425 and direct links 435 may include traffic for low-latency applications and latency-tolerant traffic sharing the wireless communication medium.

A first STA may indicate to its associated AP a sequence of time periods during which the first STA will be unavailable for frame exchanges with the AP. During the unavailability with the AP, the first STA may be involved in P2P communication with a second STA.

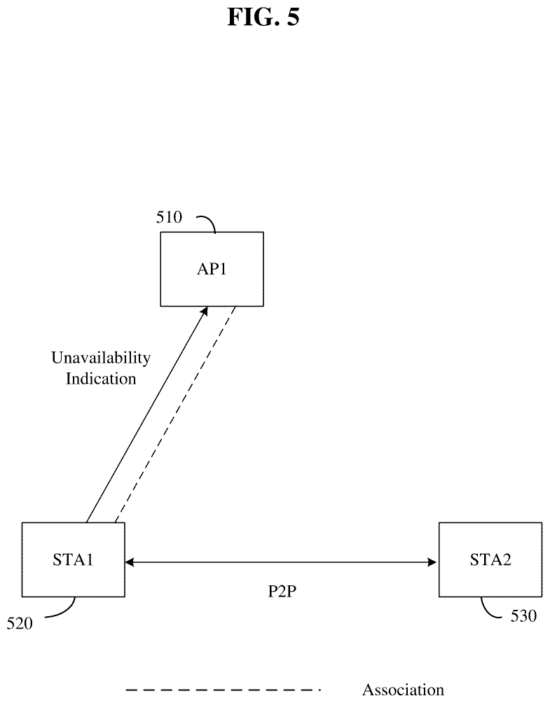

FIG. 5 shows a STA1 520 indicating to its associated AP 510 time periods during which STA1 520 will be unavailable for frame exchange with AP 510 due to scheduled P2P communication with STA2 530 in accordance with one embodiment.

In one embodiment, the first STA may also be unavailable due to scheduled coexistence (coex) event, for example, with a second STA.

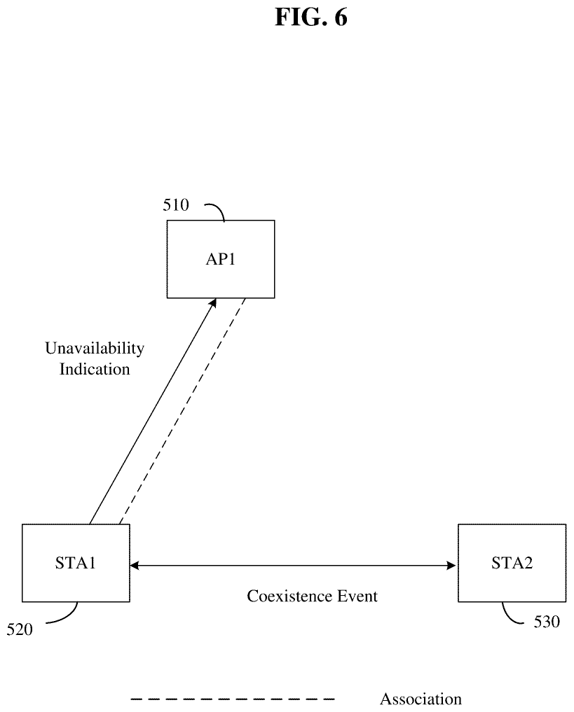

FIG. 6 shows a STA1 520 indicating to its associated AP 510 time periods during which STA1 520 will be unavailable for frame exchange with AP 510 due to scheduled P2P coex event with STA2 530 in accordance with one embodiment.

A baseline configuration for unavailability indication from a STA may not provide flexibility for the associated AP to prioritize low-latency traffic in the network. For example, in a scenario where a first STA has set up an unavailability schedule or peer-to-peer target wake time (TWT) schedule with its associated AP, the first STA does not have a mechanism to change the parameters of the unavailability service period (SP) or P2P TWT SPs without tearing down the unavailability schedule or P2P TWT schedule. (TWT SPs allow a STA to spend time in standby or low-power mode and to wake up at a scheduled service period to send or receive data).

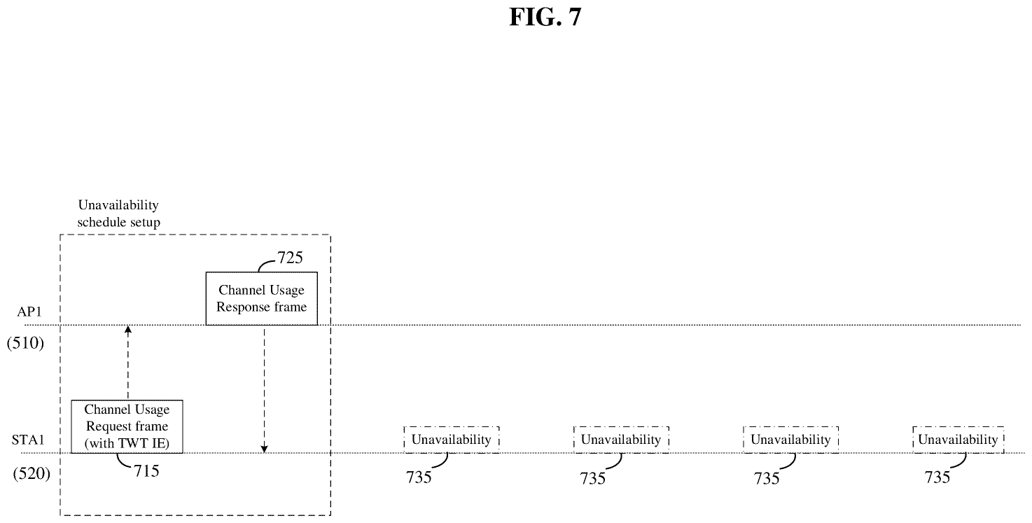

FIG. 7 shows a STA1 520 setting up an unavailability schedule or P2P TWT schedule with AP1 510 in accordance with one embodiment. STA1 520 may transmit a channel usage request frame 715 (e.g., with TWT information element (IE)) to AP1 510 to set up an unavailability or P2P TWT schedule. AP1 510 may respond to the request frame by transmitting a channel usage response frame 725 to STA1 520 to set up the unavailability or P2P TWT schedule. STA1 520 may then be unavailable to perform frame exchange with AP1 510 during a sequence of periodic unavailability SPs 735 or P2P TWT SPs.

In one scenario, after setting up the initial unavailability schedule or P2P TWT schedule with AP1 510, the STA 1 520 may want to change some parameters of the unavailability or P2P TWT schedule. For instance, the STA1 520 may want to change the start time of subsequent unavailability SPs or P2P TWT SPs of its previously set-up unavailability or P2P TWT schedule to better adapt to its traffic change. Such modifications of the unavailability SPs or P2P TWT SPs are beneficial for smooth operation with AP1 510.

Disclosed herein is a mechanism and framework for a STA to change parameters of the unavailability schedule or peer-to-peer TWT schedule that has been set up with an AP. According to one embodiment, for the scenario where a first STA has established an unavailability schedule or P2P TWT schedule with its associated AP indicating a sequence of time windows or service periods (SP) during which the first STA might be unavailable for communication with the AP, the first STA can send a message to the AP to indicate changes in the parameters that describe the unavailability or P2P TWT schedule previously agreed on. According to one embodiment, the first STA can indicate a change in the start time of subsequent unavailability SP or P2P TWT SP. According to another example, the first STA may indicate a change in the end time of the subsequent unavailability SP or P2P TWT SP.

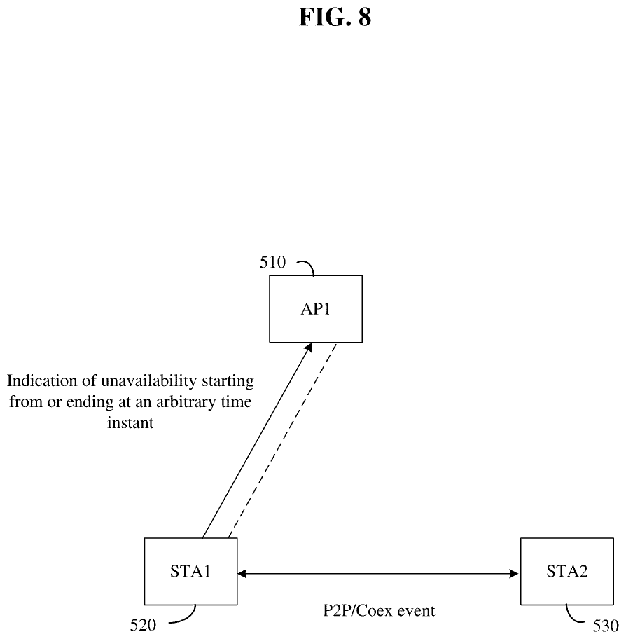

FIG. 8 shows a STA1 520 indicating to its associated AP 510 a change to the scheduled start or end time of future unavailability SP or P2P TWT SP in accordance with one embodiment. For example, STA1 520 may indicate to AP1 510 an arbitrary time instant of the start or end time of one or more upcoming unavailability SPs or P2P TWT SPs.

According to one embodiment, a change to the start time of the SPs may be made to the scenario where a first STA has established an unavailability schedule or P2P TWT schedule with its associated AP indicating a sequence of time windows or service periods (SPs) during which the first STA might be unavailable for communication with the AP. If, according to this agreement, the subsequent unavailability SP or P2P TWT SP's nominal start time is T1, then the first STA may send a message to the AP indicating that it intends to change the subsequent or upcoming SP's start time to T2, where T1<T2. In other words, the first STA may indicate to delay the unavailability SP or P2P TWT SP's start time compared to the nominal SP start time based on the previous agreement.

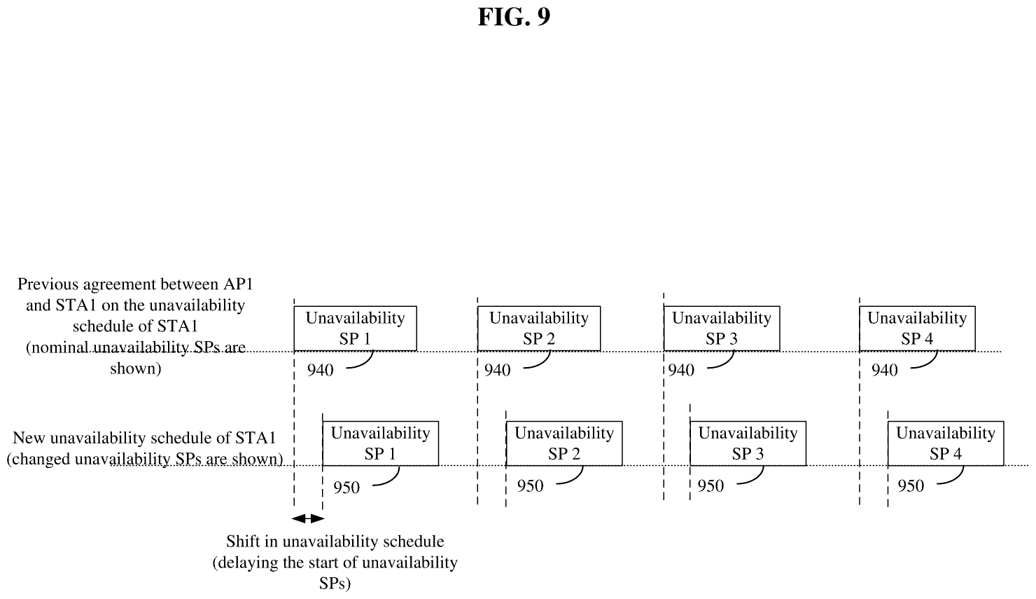

FIG. 9 shows a delay to the nominal start time of the unavailability SP or P2P TWT SP that has been established based on a previous agreement in accordance with one embodiment. The periodic sequence of nominal unavailability SPs 940 is scheduled based on the previous agreement between STA1 and AP (e.g., STA1 520 and AP 510 of FIG. 8). STA1 520 may indicate to AP 510 a time shift to the nominal unavailability SPs 940, resulting in the changed sequence of unavailability SPs 950, where their start time is delayed with respect to that of the nominal unavailability SPs 940 while the period and the time interval of the unavailability SPs remain unchanged.

According to another embodiment of a change to the start time of the SPs, if the subsequent unavailability SP or P2P TWT SP's nominal start time is T1 according to a previous agreement between a first STA and its associated AP, then the first STA may send a message to the AP indicating that it intends to change the subsequent SP's start time to T2, where T1>T2. In other words, the first STA may indicate to advance the P2P TWT SP's start time compared to the nominal SP start time based on the previous agreement.

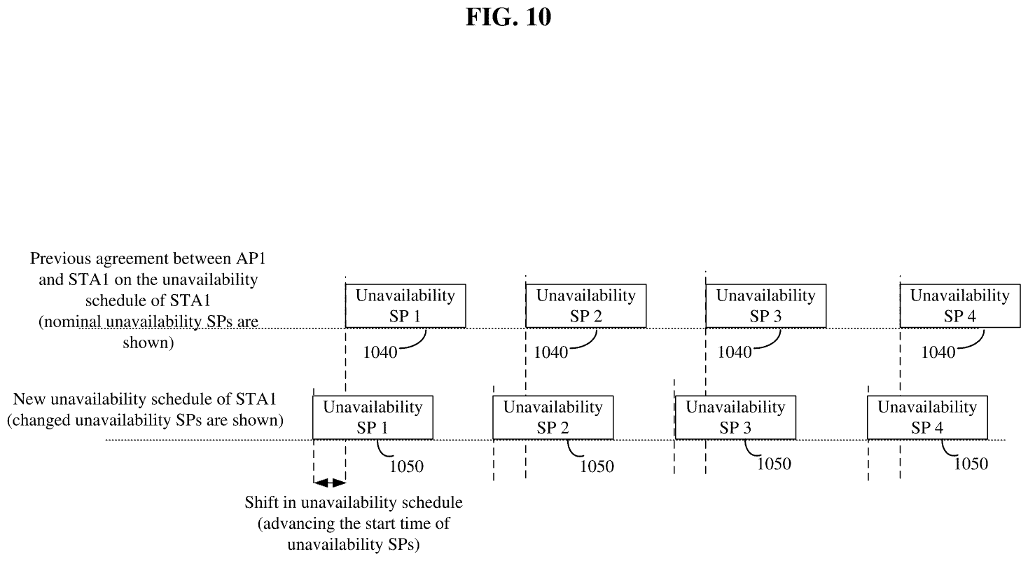

FIG. 10 shows an advance to the nominal start time of the unavailability SP or P2P TWT SP that has been established based on a previous agreement in accordance with one embodiment. The periodic sequence of nominal unavailability SPs 1040 is scheduled based on the previous agreement between STA1 520 and AP 510. STA1 520 may indicate to AP 510 a time shift to the nominal unavailability SPs 1040, resulting in the changed sequence of unavailability SPs 1050, where their start time is advanced with respect to that of the nominal unavailability SPs 1040 while the period and the time interval of the unavailability SPs remain unchanged.

According to another embodiment, a change to the end time of the SPs may be made to the scenario where a first STA has established an unavailability schedule or P2P TWT schedule with its associated AP indicating a sequence of time windows or service periods (SPs) during which the first STA might be unavailable for communication with the AP. If, according to this agreement, the subsequent unavailability SP or P2P TWT SP's nominal end time is T1, then the first STA may send a message to the AP indicating that it intends to change the subsequent or upcoming SP's end time to T2, where T1<T2. In other words, the first STA may indicate to delay the unavailability SP or P2P TWT SP end time compared to the nominal SP end time based on the previous agreement.

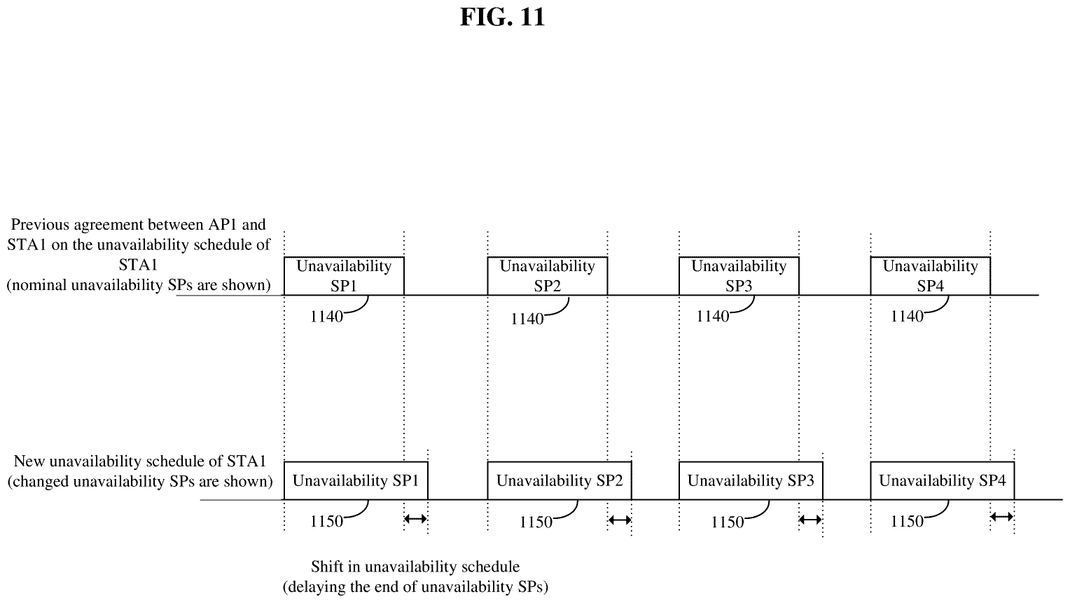

FIG. 11 shows a delay to the nominal end time of the unavailability SP or P2P TWT SP that has been established based on a previous agreement in accordance with one embodiment. The periodic sequence of nominal unavailability SPs 1140 is scheduled based on the previous agreement between STA1 520 and AP 510. STA1 520 may indicate to AP 510 a time shift to the end time of nominal unavailability SPs 1140, resulting in the changed sequence of unavailability SPs 1150, where their end time is delayed with respect to that of the nominal unavailability SPs 1140 while the start time of the unavailability SPs 1150 remains unchanged. By delaying the nominal SP end time, STA1 520 has effectively lengthened nominal unavailability SPs 1140.

According to another embodiment of a change to the end time of the SPs, if the subsequent unavailability SP or P2P TWT SP's nominal end time is T1 according to a previous agreement between a first STA and its associated AP, then the first STA may send a message to the AP indicating that it intends to change the subsequent SP's end time to T2, where T1>T2. In other words, the first STA may indicate to advance the P2P TWT SP's end time compared to the nominal SP end time based on the previous agreement.

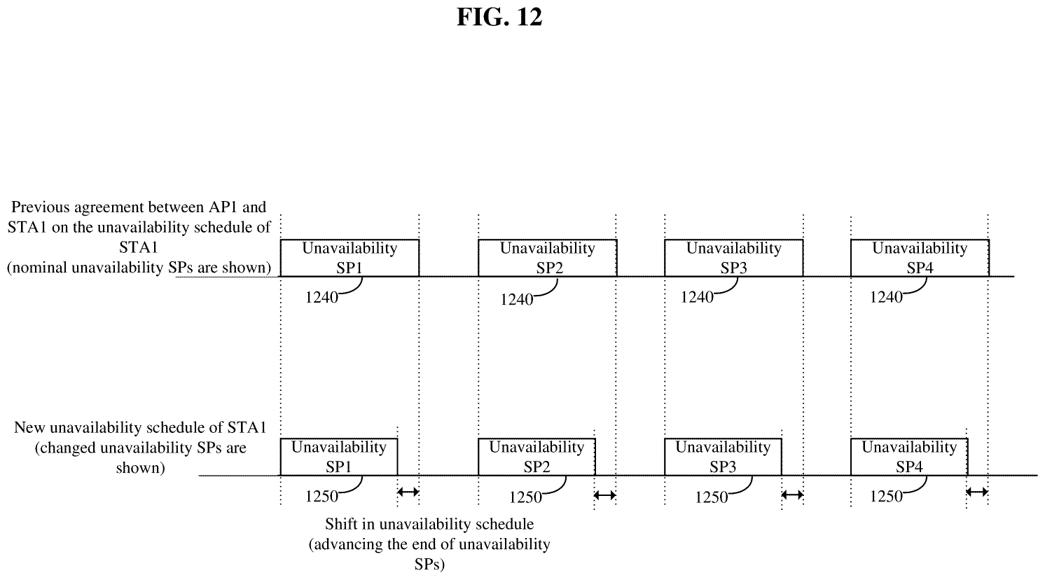

FIG. 12 shows a delay to the nominal end time of the unavailability SP or P2P TWT SP that has been established based on a previous agreement in accordance with one embodiment. The periodic sequence of nominal unavailability SPs 1240 is scheduled based on the previous agreement between STA1 520 and AP 510. STA1 520 may indicate to AP 510 a time shift to the end time of nominal unavailability SPs 1240, resulting in the changed sequence of unavailability SPs 1250, where their end time is advanced with respect to that of the nominal unavailability SPs 1140 while the start time of the unavailability SPs 1150 remains unchanged. By advancing the nominal SP end time, STA1 520 has effectively shortened nominal unavailability SPs 1240.

According to one embodiment, for the scenario where a first STA has established an unavailability schedule or P2P TWT schedule with its associated AP indicating a sequence of time windows or service periods (SP) during which the first STA might be unavailable for communication with the AP, the first STA may send a message to the AP to indicate changes in the value of the period of the unavailability schedule or P2P TWT schedule. According to another embodiment, the first STA may send a message to the AP to indicate changes in the value of the interval of the unavailability schedule or P2P TWT schedule.

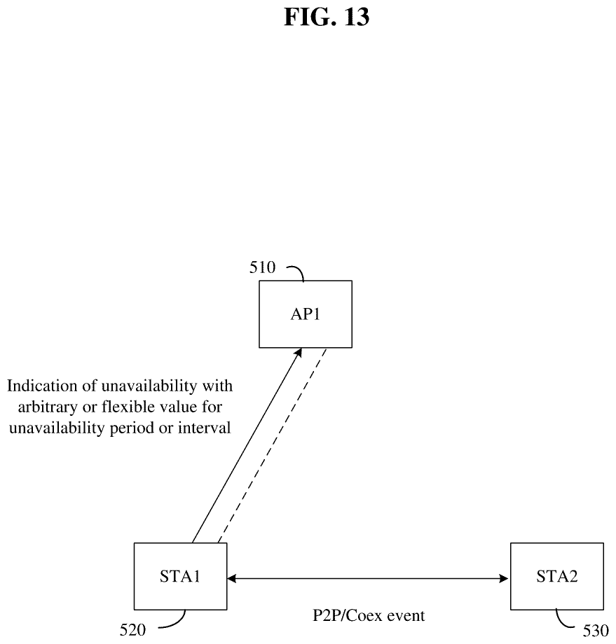

FIG. 13 shows a STA1 520 indicating to its associated AP 510 a change to the period or interval of future unavailability SP or P2P TWT SP in accordance with one embodiment. For example, STA1 520 may indicate to AP1 510 an arbitrary or a flexible value of the period of a sequence of upcoming unavailability SPs or P2P TWT SPs, or an arbitrary or a flexible value of the time interval of one or more upcoming unavailability SPs or P2P TWT SPs. The result of a change to the time interval of unavailability SP or P2P TWT SP may be to lengthen or shorten the nominal unavailability SP scheduled based on a previous agreement between STA1 520 and AP 510, as shown in FIG. 11 and FIG. 12.

In one embodiment, STA1 520 may change both the nominal start time and the interval of the unavailability SP or P2P TWT SP. In one embodiment, STA1 520 may change other parameters of the nominal unavailability SP or P2P TWT SP scheduled based on the previous agreement between STA1 520 and AP 510.

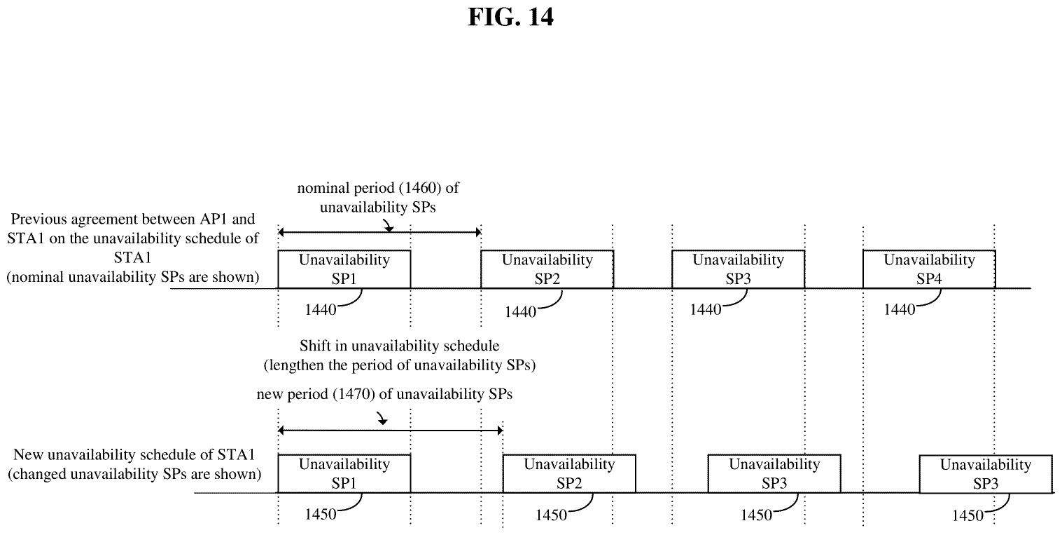

FIG. 14 shows a change to the nominal period 1460 of the unavailability SP or P2P TWT SP that has been established based on a previous agreement in accordance with one embodiment. The periodic sequence of nominal unavailability SPs 1440 is scheduled based on the previous agreement between STA1 520 and AP 510. STA1 520 may indicate to AP 510 a change to nominal period 1460 of nominal unavailability SPs 1440, resulting in the changed sequence of unavailability SPs 1450, where the new period 1470 of changed unavailability SPs 1450 is longer than nominal period 1460 of nominal unavailability SPs 1440 while the time intervals of nominal unavailability SPs 1440 and changed unavailability SPs 1450 remain the same.

According to one embodiment, changes to the parameters of the unavailability SP or P2P TWT SP, where the unavailability SP or P2P TWT SP has been established based on a previous agreement, may take effect immediately. For example, if the subsequent unavailability SP or P2P TWT SP's nominal start time is T1 according to the agreement, then the first STA may send a message to the AP indicating that it intends to change the subsequent SP's start time to T2, starting from the immediately next SP.

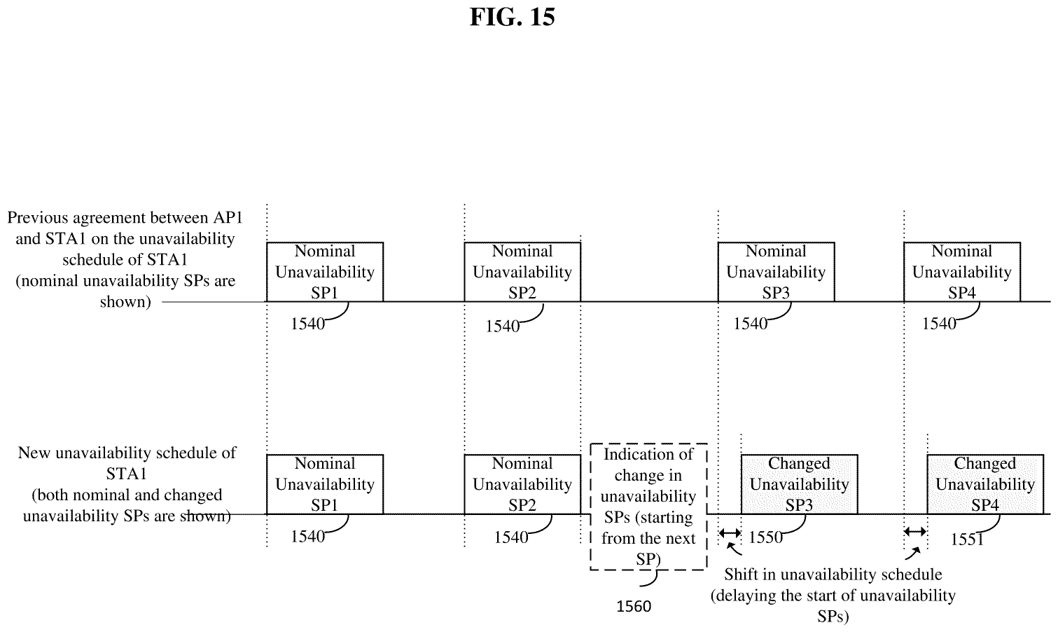

FIG. 15 shows a delay to the nominal start time of the unavailability SP or P2P TWT SP that has been established based on a previous agreement where the delay takes effect starting from the next unavailability SP or P2P TWT SP after STA1 520 indicates the delay in accordance with one embodiment. The periodic sequence of nominal unavailability SPs 1540 is scheduled based on the previous agreement between STA1 520 and AP 510. STA1 520 may indicate 1560 to AP 510 a change to the nominal unavailability SPs 1540, resulting in the sequence of changed unavailability SPs 1550 and 1551, where their start time is delayed with respect to that of the nominal unavailability SPs 1540 starting from the immediately next SP 1550 after STA1 indicates 1560 the change.

According to one embodiment, changes to the parameters of the unavailability SP or P2P TWT SP, where the unavailability SP or P2P TWT SP has been established based on a previous agreement, may take effect with a delay. For example, if the subsequent unavailability SP or P2P TWT SP's nominal start time is T1 according to the agreement, then the first STA may send a message to the AP indicating that it intends to change the subsequent SP's start time to T2, starting from the k-th next SP after the first STA sends the message.

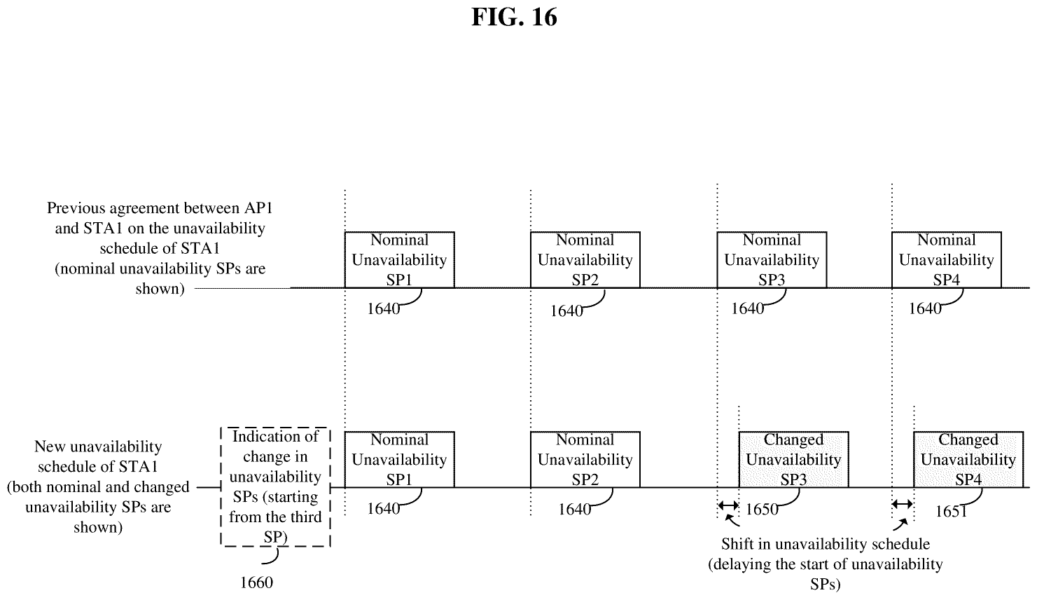

FIG. 16 shows a delay to the nominal start time of the unavailability SP or P2P TWT SP that has been established based on a previous agreement where the delay takes effect starting from the third unavailability SP or P2P TWT SP after STA1 520 indicates the delay in accordance with one embodiment. The periodic sequence of nominal unavailability SPs 1640 is scheduled based on the previous agreement between STA1 520 and AP 510. STA1 520 may indicate 1660 to AP 510 a change to the nominal unavailability SPs 1640 starting from the third SP after the indication 1660. The result is that the nominal start time of the first two unavailability SPs 1640 after the indication 1660 (nominal unavailability SP1 and nominal unavailability SP2) remain unchanged. Starting from the third unavailability SPs after the indication 1660, the start time of changed unavailability SP3 (1650) and changed unavailability SP4 (1651) is delayed with respect to that of the nominal unavailability SPs 1640.

According to one embodiment, changes to the parameters of the unavailability SP or P2P TWT SP, where the unavailability SP or P2P TWT SP has been established based on a previous agreement, may be indicated using a modification request frame. For example, if the subsequent unavailability SP or P2P TWT SP's nominal start time is T1 and has a parameter set S1 according to the agreement, then if the first STA intends to change any parameter of the previous schedule including the start time of the SPs, then the first STA may send an unavailability modification request frame to the AP indicating the intended changes. In one embodiment, the request frame may contain a TWT information element (IE) that contains the TWT parameter set corresponding to the new P2P TWT schedule or unavailability schedule. According to one embodiment, when the AP receives the unavailability modification request frame, the AP may send an unavailability modification response frame back to the first STA to indicate its response, e.g. accept the requested changes, reject the requested changes, suggest alternate changes, etc.

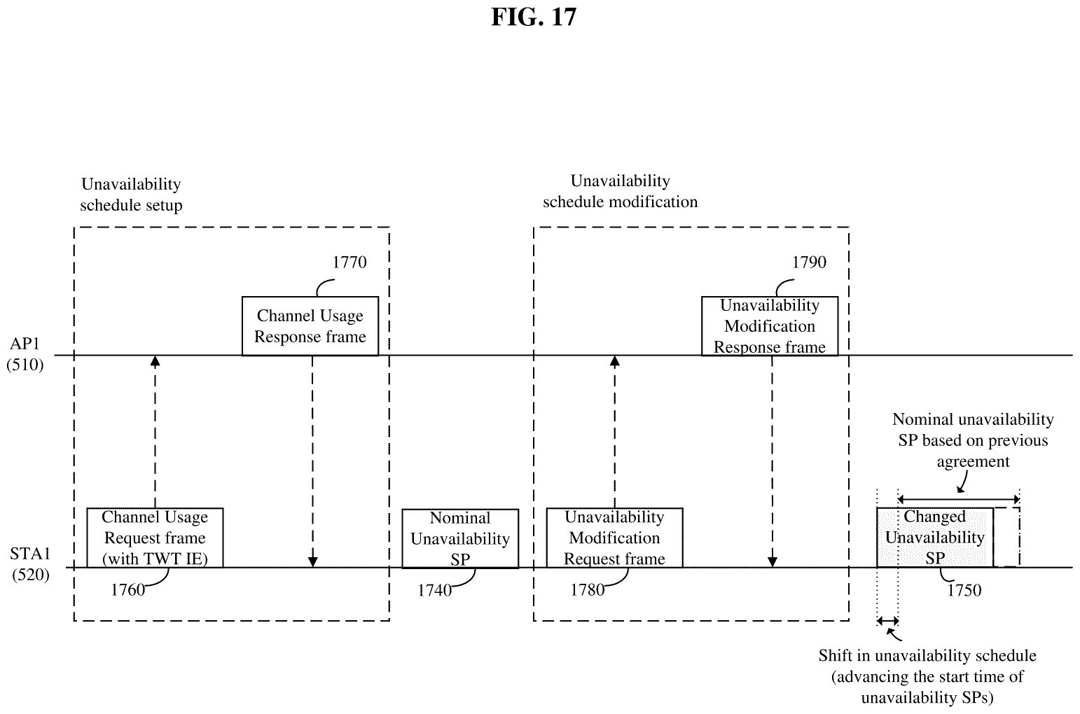

FIG. 17 shows STA1 520 and AP1 510 exchanging unavailability modification request and response frames to modify parameters of the unavailability SP or P2P TWT SP established based on a previous agreement between STA1 520 and AP1 510 in accordance with one embodiment. To establish the unavailability schedule, STA1 520 may send a channel usage request frame 1760 containing a TWT IE containing a TWT parameter set to AP1 510 and AP1 510 may send a channel usage response frame 1770 back to STA1 520. The TWT parameter set may set up a sequence of nominal unavailability SPs 1740.

If STA1 520 intends to change the parameters of nominal unavailability SPs 1740 (e.g., advancing the nominal start time), STA1 520 may send an unavailability modification request frame 1780 to AP1 510 to request the change. The unavailability modification request frame 1780 may contain a TWT IE corresponding to the new start time. AP1 510 may send an unavailability modification response frame 1790 to STA1 520 accepting the requested change. The exchange of unavailability modification request and response frames modifies the unavailability schedule, resulting in a changed unavailability SP 1750 whose start time is advanced with respect to the start time of nominal unavailability SP 1740.

In one embodiment, a possible format of the unavailability modification request frame is shown in Table I.

TABLE I
A possible format of the Unavailability
Modification Request frame

| Order | Information |
|---|---|
| 1 | Category |
| 2 | Unprotected S1G Action |
| 3 | Dialog Token |
| 4 | WNM Action |
| 5 | Channel Usage Elements |
| 6 | Supported Operating Classes Element |
| 7 | TWT Elements |
| 8 | Timeout Interval Element |
| 9 | HT Capabilities Element |
| 10 | VHT Capabilities Element |
| 11 | HE Capabilities Element |
| 12 | HE 6 GHz Capabilities Element |
| 13 | EHT Capabilities Element |

In one embodiment, a possible format of the unavailability modification response frame is shown in Table II.

TABLE II
A possible format of the Unavailability
Modification Response frame

| Order | Information |
|---|---|
| 1 | Category |
| 2 | Unprotected S1G Action |
| 3 | Dialog Token |
| 4 | WNM Action |
| 5 | Channel Usage Elements |
| 6 | Supported Operating Classes Element |
| 7 | TWT Elements |
| 8 | Timeout Interval Element |
| 9 | HT Capabilities Element |
| 10 | VHT Capabilities Element |
| 11 | HE Capabilities Element |
| 12 | HE 6 GHz Capabilities Element |
| 13 | EHT Capabilities Element |
| 14 | Status Code |
| 15 | Reason Code |

According to another embodiment of the mechanism for modifying parameters of the unavailability SP or P2P TWT SP established based on a previous agreement between a first STA and its associated AP, the first STA may send a TWT information frame to the AP indicating the intended changes. In one embodiment, the TWT information frame may contain the next TWT subfield to indicate the changes corresponding to the new P2P TWT schedule or unavailability schedule. According to one embodiment, when the AP receives the TWT information frame, the AP may send an acknowledge frame back to the first STA to indicate its response, e.g., accept the requested changes, reject the requested changes, suggest alternate changes, etc.

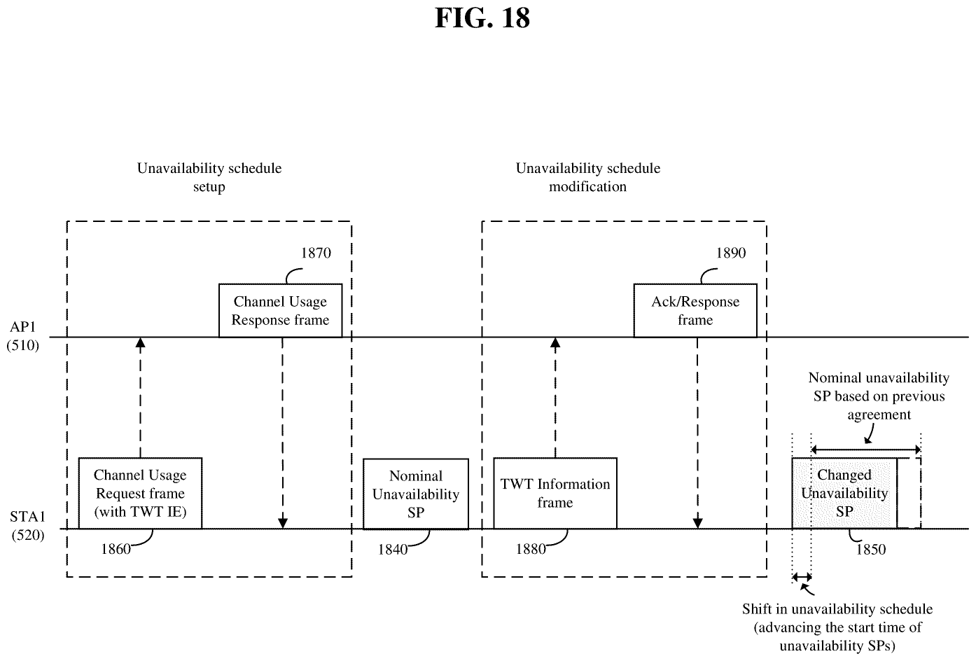

FIG. 18 shows STA1 520 and AP1 510 exchanging TWT information and response frames to modify parameters of the unavailability SP or P2P TWT SP established based on a previous agreement between STA1 520 and AP1 510 in accordance with one embodiment. To establish the unavailability schedule, STA1 520 may send a channel usage request frame 1860 containing a TWT IE containing a TWT parameter set to AP1 510 and AP1 510 may send a channel usage response frame 1870 back to STA1 520 as in FIG. 17. The TWT parameter set may set up a sequence of nominal unavailability SPs 1840.

If STA1 520 intends to change the parameters of nominal unavailability SPs 1840 (e.g., advancing the nominal start time), STA1 520 may send a TWT information frame 1880 to AP1 510 to request the change. The TWT information frame 1880 may contain the next TWT subfield to indicate the changes corresponding to the new start time. AP1 510 may send an acknowledgement/response frame 1890 to STA1 520 accepting the requested change. The exchange of TWT information and response frames modifies the unavailability schedule, resulting in a changed unavailability SP 1850 whose start time is advanced with respect to the start time of nominal unavailability SP 1840.

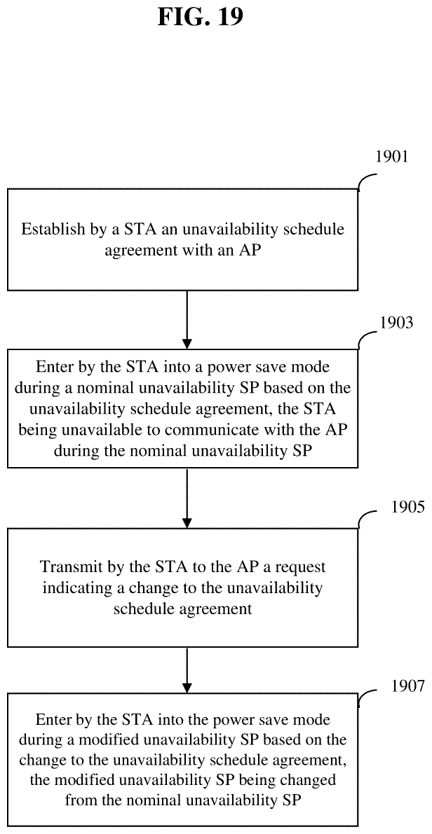

FIG. 19 shows a flow diagram of a method 1900 of a STA modifying the unavailability SP or P2P TWT SP with an AP in accordance with one embodiment. In one aspect, method 1900 may be performed by an initiator such as STA1 520 of FIG. 5 utilizing hardware, software, or combinations of hardware and software.

In operation 1901, the STA establishes an unavailability schedule agreement with an AP associated with the STA. The unavailability schedule agreement includes one or more unavailability SPs during which the STA will be unavailable for frame exchange with the AP due to scheduled P2P communication with a second STA.

In operation 1903, the STA enters a power save mode during a nominal unavailability SP based on the unavailability schedule agreement. The STA is unavailable to communicate with the AP during the nominal unavailability SP.

In operation 1905, the STA transmits to the AP a request indicating a change to the unavailability schedule agreement. In one embodiment, the change to the unavailability schedule agreement includes a change to the start time of the nominal unavailability SP; a change to the end time of the nominal unavailability SP; a change to a period of a sequence of unavailability SPs; or a change to an interval of the nominal unavailability SP. In one embodiment, the STA transmits to the AP an unavailability modification request frame. The unavailability modification request frame indicates a change to a TWT parameter associated with the nominal unavailability SP. The STA receives from the AP an unavailability modification response frame that accepts the change to the TWT parameter. In one embodiment, the change to the unavailability schedule agreement is to start from the next nominal unavailability SP following the request. In one embodiment, the change to the unavailability schedule agreement is to start from the k-th nominal unavailability SP following the request

In operation 1907, the STA enters the power save mode during a modified unavailability SP based on the change to the unavailability schedule agreement. The modified unavailability SP is changed from the nominal unavailability SP. In one embodiment, the modified unavailability SP may have a different start time, a different end time, a different period, and/or a different interval from that of the nominal unavailability SP.

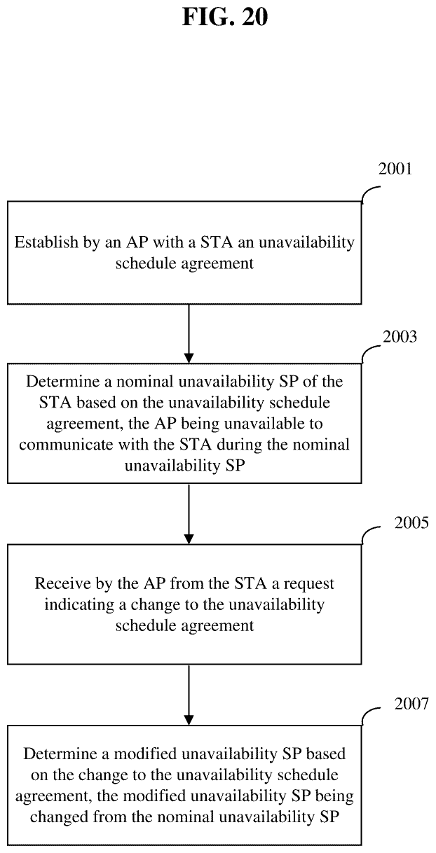

FIG. 20 shows a flow diagram of a method 2000 of an AP receiving a request from an AP to modify the unavailability SP or P2P TWT SP in accordance with one embodiment. In one aspect, method 1900 may be performed by an initiator such as AP1 510 of FIG. 5 utilizing hardware, software, or combinations of hardware and software.

In operation 2001, the AP establishes an unavailability schedule agreement with a STA associated with the STA. The unavailability schedule agreement includes one or more unavailability SPs during which the AP will be unavailable for frame exchange with the STA due to scheduled P2P communication of the STA with a second STA.

In operation 2003, the AP determines a nominal unavailability SP of the STA based on the unavailability schedule agreement. The AP is unavailable to communicate with the STA during the nominal unavailability SP.

In operation 2005, the AP receives from the STA a request indicating a change to the unavailability schedule agreement. In one embodiment, the change to the unavailability schedule agreement includes a change to the start time of the nominal unavailability SP; a change to the end time of the nominal unavailability SP; a change to a period of a sequence of unavailability SPs; or a change to an interval of the nominal unavailability SP. In one embodiment, the AP receives from the STA an unavailability modification request frame. The unavailability modification request frame indicates a change to a TWT parameter associated with the nominal unavailability schedule SP. The AP transmits to the STA an unavailability modification response frame that accepts the change to the TWT parameter. In one embodiment, the change to the unavailability schedule agreement is to start from the next nominal unavailability SP following the request. In one embodiment, the change to the unavailability schedule agreement is to start from the k-th nominal unavailability SP following the request

In operation 2007, the AP determines a modified unavailability SP based on the change to the unavailability schedule agreement. The modified unavailability SP is changed from the nominal unavailability SP. In one embodiment, the modified unavailability SP may have a different start time, a different end time, a different period, and/or a different interval from that of the nominal unavailability schedule SP.

The disclosure presents various embodiments of a STA modifying the nominal unavailability SPs or P2P TWT SPs. The disclosed techniques enable the next generation WLAN system to have mechanisms to better handle traffic to prioritize the low-latency traffic in the network.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
establishing an unavailability schedule agreement with an access point (AP);
entering a power save mode during a nominal unavailability service period (SP) based on the unavailability schedule agreement, the STA being unavailable to communicate with the AP during the nominal unavailability SP;
transmitting, to the AP, a request indicating a change to the unavailability schedule agreement; and
entering the power save mode during a modified unavailability SP based on the change to the unavailability schedule agreement, the modified unavailability SP being changed from the nominal unavailability SP.

2. The STA of claim 1, wherein the establishing the unavailability schedule agreement comprises:
transmitting, to the AP, a channel usage request frame, wherein the channel usage request frame includes a set of target wake time (TWT) parameters associated with the nominal unavailability SP; and
receiving, from the AP, a channel usage response frame that accepts the set of TWT parameters.

3. The STA of claim 2, wherein the TWT parameters comprise one or more of:
a start time of the nominal unavailability SP;
an end time of the nominal unavailability SP;
a period of a sequence of nominal unavailability SPs; or
an interval of the nominal unavailability SP.

4. The STA of claim 1, wherein the transmitting the request indicating the change to the unavailability schedule agreement comprises:
transmitting, to the AP, an unavailability modification request frame, wherein the unavailability modification request frame indicates a change to a target wake time (TWT) parameter associated with the nominal unavailability SP; and
receiving, from the AP, an unavailability modification response frame that accepts the change to the TWT parameter.

5. The STA of claim 4, wherein the change to the TWT parameter comprises a change to one or more of:
a start time of the nominal unavailability SP;
an end time of the nominal unavailability SP;
a period of a plurality of the nominal unavailability SPs; or
an interval of the nominal unavailability SP.

6. The STA of claim 1, wherein the request indicates the change to the unavailability schedule agreement starting from a next nominal unavailability SP of a sequence of nominal unavailability SPs following the request.

7. The STA of claim 1, wherein the request indicates the change to the unavailability schedule agreement starting from a k-th nominal unavailability SP of a sequence of nominal unavailability SPs following the request.

8. The STA of claim 1, wherein the transmitting the request indicating the change to the unavailability schedule agreement comprises:
transmitting, to the AP, a target wake time (TWT) information frame, wherein the TWT information frame indicates a change to a TWT parameter associated with the nominal unavailability SP; and
receiving, from the AP, a response frame that accepts the change to the TWT parameter.

9. An access point (AP) in a wireless network, comprising:
a memory; and
a processor coupled to the memory, the processor configured to cause:
establishing an unavailability schedule agreement with a station (STA);
determining a nominal unavailability service period (SP) of the STA based on the unavailability schedule agreement, the AP being unavailable to communicate with the STA during the nominal unavailability SP;
receiving, from the STA, a request indicating a change to the unavailability schedule agreement; and
determining a modified unavailability SP based on the change to the unavailability schedule agreement, the modified unavailability SP being changed from the nominal unavailability SP.

10. The AP of claim 9, wherein the establishing the unavailability schedule agreement comprises:
receiving, from the STA, a channel usage request frame, wherein the channel usage request frame includes a set of target wake time (TWT) parameters associated with the nominal unavailability SP; and
transmitting, to the STA, a channel usage response frame that accepts the set of TWT parameters.

11. The AP of claim 10, wherein the TWT parameters comprise one or more of:
a start time of the nominal unavailability SP;
an end time of the nominal unavailability SP;
a period of a sequence of nominal unavailability SPs; or
an interval of the nominal unavailability SP.

12. The AP of claim 9, wherein the receiving the request indicating the change to the unavailability schedule agreement comprises:
receiving, from the STA, an unavailability modification request frame, wherein the unavailability modification request frame indicates a change to a target wake time (TWT) parameter associated with the nominal unavailability SP; and
transmitting, to the STA, an unavailability modification response frame that accepts the change to the TWT parameter.

13. The AP of claim 12, wherein the change to the TWT parameter comprises a change to one or more of:
a start time of the nominal unavailability SP;
an end time of the nominal unavailability SP;
a period of a plurality of the nominal unavailability SPs; or
an interval of the nominal unavailability SP.

14. The AP of claim 9, wherein the request indicates the change to the unavailability schedule agreement starting from a next nominal unavailability SP of a sequence of nominal unavailability SPs following the request.

15. The AP of claim of claim 9, wherein the request indicates the change to the unavailability schedule agreement starting from a k-th nominal unavailability SP of a sequence of nominal unavailability SPs following the request.

16. The AP of claim 9, wherein the receiving the request indicating the change to the unavailability schedule agreement comprises:
receiving, from the STA, a target wake time (TWT) information frame, wherein the TWT information frame indicates a change to a TWT parameter associated with the nominal unavailability SP; and
transmitting, to the STA, a response frame that accepts the change to the TWT parameter.

17. A method performed by a station (STA) in a wireless network, comprising:
establishing an unavailability schedule agreement with an access point (AP);
entering a power save mode during a nominal unavailability service period (SP) based on the unavailability schedule agreement, the STA being unavailable to communicate with the AP during the nominal unavailability SP;
transmitting, to the AP, a request indicating a change to the unavailability schedule agreement; and
entering the power save mode during a modified unavailability SP based on the change to the unavailability schedule agreement, the modified unavailability SP being changed from the nominal unavailability SP.

18. The method of claim 17, wherein establishing the unavailability schedule agreement comprises:
transmitting, to the AP, a channel usage request frame, wherein the channel usage request frame includes a set of target wake time (TWT) parameters associated with the nominal unavailability SP; and
receiving, from the AP, a channel usage response frame that accepts the set of TWT parameters, wherein the TWT parameters comprise one or more of:
a start time of the nominal unavailability SP;
an end time of the nominal unavailability SP;
a period of a sequence of nominal unavailability SPs; or
an interval of the nominal unavailability SP.

19. The method of claim 17, wherein the transmitting the request indicating the change to the unavailability schedule agreement comprises:
transmitting, to the AP, one of an unavailability modification request frame or a target wake time (TWT) information frame, wherein the unavailability modification request frame or the TWT information frame indicates a change to a TWT parameter associated with the nominal unavailability SP; and
receiving, from the AP, a response frame that accepts the change to the TWT parameter, wherein the change to the TWT parameter comprises a change to one or more of:
a start time of the nominal unavailability SP;
an end time of the nominal unavailability SP;
a period of a plurality of the nominal unavailability SPs; or
an interval of the nominal unavailability SP.

20. The method of claim 17, wherein the request indicates the change to the unavailability schedule agreement starting from one of a next nominal unavailability SP or a k-th nominal unavailability SP of a sequence of nominal unavailability SPs following the request.
